(19) United States
(12) Patent Application Publication
(10) Pub. No.: US 2023/0043178 A1
(43) Pub. Date: Feb. 9, 2023

(54) METHOD FOR TREATING EXHAUST GAS OF THERMAL POWER PLANT

(71) Applicant: EMKO CO.,LTD., Seoul (KR)

(72) Inventors: Han Jae JO, Hwaseong-si Gyeonggi-do (KR); Seung Jae LEE, Seoul (KR)

(21) Appl. No.: 17/791,045

(22) PCT Filed: Dec. 4, 2020
(86) PCT No.: PCT/KR2020/017649

§ 371 Date: Jul. 6, 2022

(30) Foreign Application Priority Data
Jan. 8, 2020 (KR) 10-2020-0002471

(51) Int. Cl. B01D 53/94

(52) U.S. Cl. CPC B01D 53/9418; B01D 2251/2062; B01D 2251/208; B01D 2257/404; B01D 2258/01

(57) ABSTRACT

A method for treating exhaust gas of a thermal power plant comprises the steps of: (A) forming a contact exhaust gas by contacting a reducing agent including a hydrocarbon-based reducing agent and an ammonia-based reducing agent, with a nitrogen oxide-containing exhaust gas at 300° C. to 500° C. at the front end of a denitration catalyst; and (B) forming a catalyst-contacted exhaust gas by contacting the denitration catalyst with the contact exhaust gas. According to the method, the exhaust gas of a thermal power plant can be treated very effectively and efficiently.

### TECHNICAL FIELD

The present invention relates to an exhaust gas treatment method and, more particularly, to a method of processing an exhaust gas of a thermal power plant.

### BACKGROUND ART

Electricity is generally produced in large-scale power generation facilities. For electricity generation, thermal power generation, nuclear power generation, and hydroelectric power generation that respectively use fuel, nuclear energy, and moving water as necessary energy are mainly used. On the other hand, there are a minority of power generation methods that use solar heat, tidal power, and wind power.

Among them, the thermal power generation is the most widely used power generation method. This method drives a turbine by burning fuel. Thermal power generation requires fuel to be consumed continuously. Specifically, fuel is burned in a gas turbine while producing a large amount of exhaust gas. Since the exhaust gas contains various pollutants generated during combustion or high-temperature thermal reactions of fuel, the exhaust gas needs to undergo a special purification process before being emitted to the atmosphere.

Therefore, various types of exhaust gas purification apparatuses are used in thermal power plants. Korean Patent No. 10-1563079 discloses an exhaust gas purification apparatus. However, there is a problem in that existing exhaust gas purification apparatuses cannot satisfactorily purify exhaust gas of power plants. In particular, in a combined cycle power plant, since the operation state of a turbine fluctuates, the flow rate, velocity, and temperature of exhaust gas accordingly changes. Especially, exhaust gas generated at the initial start-up stage of a power plant is necessarily processed because this exhaust gas contains a high concentration of nitrogen dioxide (NO₂) which is one of nitrogen oxides (NOₓ). However, there is a lack of satisfactory denitration technology for this exhaust gas.

### DOCUMENTS OF RELATED ART

### Patent Document

(Patent Document 1) Korean Patent No. 10-1563079 (Oct. 30, 2015), Specification

### DISCLOSURE

### Technical Problem

The present invention has been made in view of the problems occurring in the related art, and an objective of the present invention is to provide a method of processing an exhaust gas of a thermal power plant. Specifically, the present invention provides an exhaust gas treatment method for a thermal power plant, the method being capable of effectively processing even an exhaust gas containing a high concentration of nitrogen dioxide generated during an initial start-up stage of a gas turbine of a thermal power plant.

The objectives of the present disclosure are not limited to the ones mentioned above, and other objectives not mentioned above can be clearly understood by those skilled in the art from the following description.

### Technical Solution

An exhaust gas treatment method for a thermal power plant, according to one embodiment of the present invention, includes the steps of: (A) bringing a reducing agent including a hydrocarbon-based reducing agent and an ammonia-based reducing agent into contact with a nitrogen oxide (NOₓ)-containing exhaust gas at 300° C. to 500° C. to form a contact exhaust gas at the front end of a denitration catalyst; and (B) bringing the denitration catalyst into contact with the contact exhaust gas to form a catalyst-contacted exhaust gas, in which in step (A), the contact is made at a position between a gas turbine and a heat exchange module, and the contact exhaust gas is formed by injecting the hydrocarbon-based reducing agent and the ammonia-based reducing agent into a gas passage through which the NOₓ-containing exhaust gas flows.

The contact exhaust gas may be formed by bringing both the hydrocarbon-based reducing agent and the ammonia-based reducing agent into contact with the NOₓ-containing exhaust gas.

The contact in step (A) may be made to allow the hydrocarbon-based reducing agent to reduce nitrogen dioxide (NO₂) contained in the NOₓ-containing exhaust gas into nitrogen monoxide (NO).

The hydrocarbon-based reducing agent may be included in the reducing agent in an amount of 0.5 equivalents of the nitrogen dioxide at maximum.

The contact in step (B) may be made at a temperature in a range of 200° C. to 500° C.

The concentration of nitrogen oxides in the NOₓ-containing exhaust gas may be in a range of 30 to 100 ppm.

The content of nitrogen dioxide may account for 40% to 90% by volume of the content of nitrogen oxides contained in the NOₓ-containing exhaust gas.

A ratio of nitrogen dioxide to nitrogen monoxide (NO₂/NO ratio) of the NOₓ-containing exhaust gas may exceed 1.

The hydrocarbon-based reducing agent may be used to maintain a NO₂/NO ratio in the contact exhaust gas at 2.33 or less.

A ratio of nitrogen dioxide to nitrogen monoxide (NO₂/NO) in the contact exhaust gas may be maintained at 2.33 or less by the contact made in step (A).

The contact in step (A) may be performed according to the amount of the hydrocarbon-based reducing agent adjusted depending on the measured value of a nitrogen dioxide concentration in the NOₓ-containing exhaust gas, the concentration being measured at the front end of the denitration catalyst.

The denitration catalyst may be disposed between a plurality of heat exchange modules, the plurality of heat exchange modules may comprise a first heat exchange module and a second heat exchange module, the second heat exchange module may be disposed at the rear end of the first heat exchange module, and the denitration catalyst may be disposed at the rear end of the second heat exchange module.

The method may further include the step of excluding the hydrocarbon-based reducing agent so that the reducing agent does not contain the hydrocarbon-based reducing agent.

The excluding may be carried out when the concentration of nitrogen oxides in the NOₓ-containing exhaust gas is in a range of 5 to 25 ppm.

The excluding may be performed when a gas turbine of a thermal power plant exhibits 40% or more of the maximum output.

The treatment method may further include the step of forming an additional catalyst-contacted exhaust gas by bringing the catalyst-contacted exhaust gas into an additional denitration catalyst.

The contact in the step of forming the additional catalyst-contacted exhaust gas may be made at a temperature in a range of 200° C. to 400° C.

The denitration catalyst may be disposed between a plurality of heat exchange modules, the plurality of heat exchange modules may comprise a first heat exchange module, a second heat exchange module, and a third heat exchange module, the second heat exchange module may be disposed at the rear end of the first heat exchange module, the denitration catalyst may be disposed at the rear end of the second heat exchange module, the third heat exchange module may be disposed at the rear end of the denitration catalyst, and the additional denitration catalyst may be disposed at the rear end of the third heat exchange module.

The method may further include the step of bringing the additional catalyst-contact exhaust gas into an oxidation catalyst.

The denitration catalyst may be disposed between a plurality of heat exchange modules, the plurality of heat exchange modules may comprise a first heat exchange module, a second heat exchange module, a third heat exchange module, and a fourth heat exchange module, the second heat exchange module may be disposed at the rear end of the first heat exchange module, the denitration catalyst may be disposed at the rear end of the second heat exchange module, the third heat exchange module may be disposed at the rear end of the denitration catalyst, the additional denitration catalyst may be disposed at the rear end of the third heat exchange module, the fourth heat exchange module may be disposed at the rear end of the additional denitration catalyst, and the oxidation catalyst may be disposed at the rear end of the fourth heat exchange module.

The denitration catalyst may be a dual functional catalyst having an oxidation catalytic function as well as a denitration catalytic function.

The dual functional catalyst may be structured such that a catalyst component for a denitration catalytic function and a catalyst component for an oxidation catalytic function are supported on a single carrier.

### Advantageous Effects

According to the present invention, the exhaust gas of a thermal power plant can be treated very effectively and efficiently. The present invention can exhibit a highly effective treatment effect even on exhaust gas generated at the initial start-up stage of a combined-cycle power plant.

### DESCRIPTION OF DRAWINGS

FIG. 1 is a flowchart illustrating an exhaust gas treatment method for a thermal power plant, according to one embodiment of the present invention.

FIG. 2 is a view illustrating an exhaust gas treatment apparatus with which the exhaust gas treatment method according to one embodiment of the present invention can be performed.

FIG. 3 is a view illustrating an arrangement structure according to a first modification to the exhaust gas processing apparatus of FIG. 2.

FIG. 4 is a view illustrating an arrangement structure according to a second modification to the exhaust gas processing apparatus of FIG. 2.

### BEST MODE

The advantages and features of the present invention and the manner of achieving them will become apparent with reference to the embodiments described in detail below and the accompanying drawings. The present invention may, however, be embodied in many different forms and should not be construed as being limited to the embodiments set forth herein. Rather, these embodiments are provided so that the present invention will be thorough and complete and will fully convey the concept of the invention to those skilled in the art. Thus, the present invention will be defined only by the appended claims. Like reference numbers refer to like elements throughout the description herein and the drawings.

In this specification, “front end” and “rear end” are relative concepts. In a direction in which exhaust gas flows, the exhaust gas inlet side is referred to as the front end and the exhaust gas outlet side is referred to as the rear end.

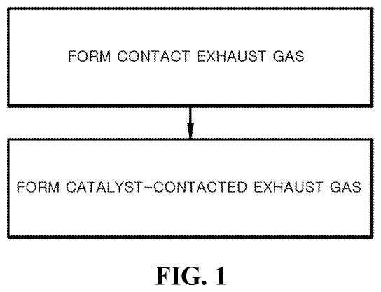

Hereinafter, a method of processing an exhaust gas of a thermal power plant (hereinafter, simply referred to as an “exhaust gas processing method”), according to an embodiment of the present invention, will be described in detail with reference to FIGS. 1 to 4.

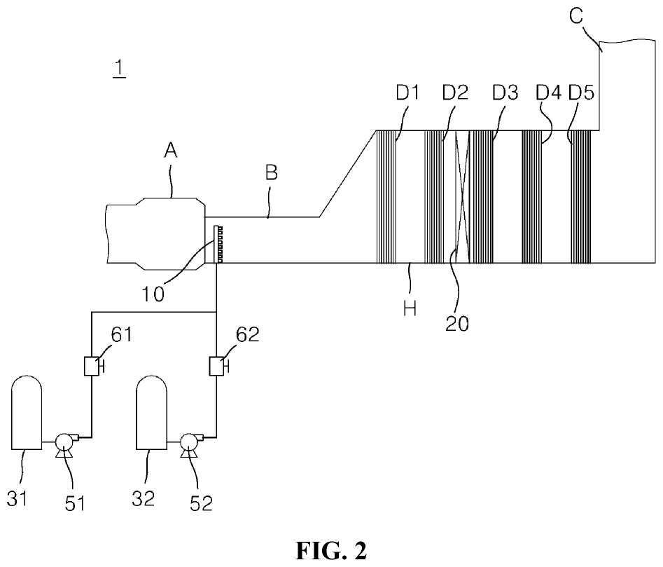

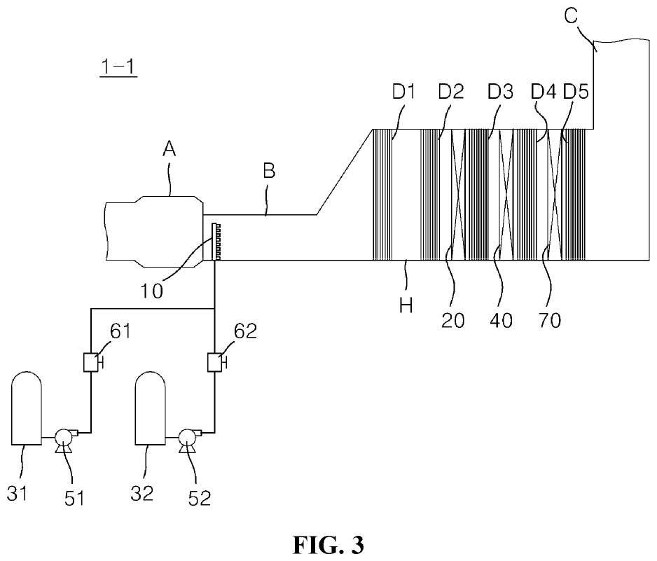

FIG. 1 is a flowchart illustrating an exhaust gas processing method for a thermal power plant, according to one embodiment of the present invention. FIG. 2 is a view illustrating an exhaust gas processing apparatus with which the exhaust gas processing method according to one embodiment of the present invention can be performed. FIG. 3 is a view illustrating an arrangement structure according to a first modification to the exhaust gas processing apparatus of FIG. 2.

The thermal power plant exhaust gas processing method according to one embodiment of the present invention includes the steps of (A) forming a contact exhaust gas; and (B) forming a catalyst-contacted exhaust gas.

Step (A) of forming a contact exhaust gas is a step of forming a contact exhaust gas by bringing a reducing agent including a hydrocarbon-based reducing agent and an ammonia-based reducing agent into contact with a nitrogen oxide (NOₓ)-containing exhaust gas at a temperature in a range of 300° C. to 500° C. at the front end of a denitration catalyst. Such a contact temperature is preferably in a range of 300° C. to 500° C., is more preferably in a range exceeding 300° C. but not exceeding higher than 500° C., and even more preferably in a range of 320° C. to 480° C. As confirmed from the experimental results, it appears that nitrogen dioxide is converted into nitrogen monoxide through a reduction reaction in such a temperature range, resulting in effective denitration. That is, within such a specific temperature range, it seems that a selective non-catalytic reduction (SNCR) reaction in which nitrogen dioxide (NO₂) is reduced to nitrogen monoxide (NO) primarily by a hydrocarbon-based reducing agent rather than by a catalyst occurs. That is, the above-described temperature range of the exhaust gas is preferable because nitrogen dioxide can be effectively reduced to nitrogen monoxide in the temperature range. In temperature ranges that is below or not higher than the specific temperature range described above, there is a concern that it is difficult to reduce nitrogen dioxide to nitrogen monoxide. In addition, there is a risk that nitrogen monoxide is oxidized to nitrogen dioxide in a temperature range higher than the specific temperature range described above. In this case, the reduction may be performed by a reaction such as a thermochemical reaction.

As nitrogen dioxide contained in the NOₓ-containing exhaust gas is reduced to nitrogen monoxide by the hydrocarbon-based reducing agent, the content of nitrogen dioxide in the contact exhaust gas becomes lower than that in the NOₓ-containing exhaust gas. In addition, since the ammonia-based reducing agent and the hydrocarbon-based reducing agent are used together and come into contact with the NOₓ-containing exhaust gas in step (A), it seems that the denitration of the catalytic reaction is more effectively performed in the subsequent step (B). The more effective denitration is assumed to be attributable to the fact that the ammonia-based reducing agent that acts to reduce nitrogen oxides by participating in a catalytic reaction in step (B) has been in sufficient contact with nitrogen oxides (in which a ratio of nitrogen dioxide to nitrogen monoxide in exhaust gas is favorably adjusted for a catalytic reaction) in step (A). This effect is confirmed through experimental examples described below.

Particularly, even an initial exhaust gas that is generated at the start-up stage of a gas turbine of a thermal power plant and which is difficult to be processed due to a high concentration of nitrogen dioxide can be effectively processed through the two steps, step (A) and step (B). In a gas turbine, combustion gas generated by burning fuel rotates a turbine, and the combustion gas is discharged from the rear end of the gas turbine as exhaust gas. A gas turbine is a rotary heat engine that drives a turbine with the use of hot high-pressure combustion gas, and the gas turbine is primarily composed of a compressor section, a combustor section, and a turbine section. Since the exhaust gas generated during the initial start-up stage of the gas turbine contains a high concentration of nitrogen dioxide, it is difficult to appropriately process the exhaust gas. However, according to the present invention, it is possible to effectively process the exhaust gas through step A and step B. That is, even though the NOₓ-containing exhaust gas initially contains a high concentration of nitrogen dioxide (i.e., a high NO₂/NO ratio), the contact exhaust gas resulting from step (A) has a lower NO₂/NO ratio due to reduction of nitrogen dioxide into nitrogen monoxide than the initial NOₓ-containing exhaust gas. At this time, the contact exhaust gas resulting from step (A) also contains an ammonia-based reducing agent. Since this contact exhaust gas comes into contact with a denitration catalyst in step (B), denitration can be effectively performed by a catalytic reaction. The reactions described below show this mechanism. Nitrogen dioxide is reduced to nitrogen monoxide by a hydrocarbon-based reducing agent such as ethanol as shown by Reaction Formula (1), and the nitrogen monoxide turns to nitrogen molecules by the action of a denitration catalyst as shown by Reaction Formula (2). In this case, the nitrogen dioxide which is not reduced by the hydrocarbon-based reducing agent in step (A) but remains to be present in the contact exhaust gas may also undergoes a forward reaction represented by Reaction Formula (2).

C₂H₅OH+NO₂+4O₂→NO+2CO₂+3H₂O+1.5O₂ (1)

2NH₃+NO₂+NO→2N₂+3H₂O (2)

When taking the reaction formulas and the test results described below into account, the hydrocarbon-based reducing agent is preferably included in the reducing agent in an amount corresponding to 0.5 equivalents of nitrogen dioxide contained in the NOₓ-containing exhaust gas at maximum. More preferably, the hydrocarbon-based reducing agent is contained in the reducing agent in an amount corresponding to 0.3 to 0.5 equivalents of nitrogen dioxide contained in the NOₓ-containing exhaust gas. For example, when the hydrocarbon-based reducing agent corresponding to 0.5 equivalents of nitrogen dioxide in the NOₓ-containing exhaust gas reacts with the nitrogen dioxide, 40% to 50% of the nitrogen dioxide contained in the exhaust gas is reduced to nitrogen monoxide, so that the ratio of the produced nitrogen monoxide through the reduction reaction and the remaining nitrogen dioxide becomes 1:1 in equivalents. Therefore, it seems that the produced nitrogen monoxide and the remaining nitrogen dioxide can be almost completely reduced to nitrogen molecules by Reaction Formula (2). On the other hand, when a certain amount of nitrogen monoxide other than the nitrogen monoxide resulting from the reduction reaction of the nitrogen dioxide is present in the NOₓ-containing exhaust gas, the ratio of the total amount of nitrogen monoxide and the amount of nitrogen dioxide becomes 1:1 even though the amount of the hydrocarbon-based reducing agent is less than 0.5 equivalents of the nitrogen dioxide contained in the NOₓ-containing exhaust gas. Therefore, with the use of a smaller amount of the hydrocarbon-based reducing agent than 0.5 equivalents of the nitrogen dioxide in the NOₓ-containing exhaust gas, the nitrogen oxides in the exhaust gas can be completely removed according to Reaction Formula (2). Therefore, it is confirmed that the present invention can effectively remove nitrogen oxides even without using an excessive amount of hydrocarbon-based reducing agent. That is, the exhaust gas can be treated by controlling the amount of the hydrocarbon-based reducing agent to be fed to come into contact with the exhaust gas according to the amount of nitrogen dioxide contained in the exhaust gas. To this end, a sensor may be used to measure the concentration of nitrogen dioxide contained in the exhaust gas, and the amount of the hydrocarbon-based reducing agent used is adjusted according to the measurements of the sensor. For example, the contact between the hydrocarbon-based reducing agent and the exhaust gas at the front end of a denitration catalyst may be adjusted by the amount of the hydrocarbon-based reducing agent, which varies depending on the measured value of the concentration of the nitrogen dioxide in the NOₓ-containing exhaust gas.

When the ratio of the amount of nitrogen dioxide to the total amount of nitrogen oxides included in exhaust gas increases under certain combustion conditions, the nitrogen dioxide can be reduced to nitrogen molecules by slow catalytic reactions represented by Reaction Formulas (3) and (4).

2NO₂+4NH₃+O₂→3N₂+6H₂O (3)

6NO₂+8NH₃→7N₂+12H₂O (4)

However, according to the present invention, although the ratio of the amount of nitrogen dioxide to the total amount of nitrogen oxides contained in exhaust gas is relatively high, the content of nitrogen dioxide in the exhaust gas is reduced and the content of nitrogen monoxide is increased by a hydrocarbon-based reducing agent before the exhaust gas comes into contact with a denitration catalyst. Thus, the reaction represented by Reaction Formula (2) is induced rather than the reactions represented by Reaction Formulas (3) and (4). Therefore, the denitration can be performed at high speed. In addition, according to the present invention, the denitration reaction can be performed in a relatively wide temperature range. That is, the contact in step (B) may preferably be made at a temperature in a range of 200° C. to 500° C. According to the present invention, it is confirmed from the test results described below that exhaust gas can be effectively denitrated in such a wide reaction temperature range. That is, according to the present invention, effective denitration occurs in such a wide reaction temperature range. When the temperature of the exhaust gas is above or below the specific temperature range described above, there is a concern that selective catalytic reduction caused by a denitration catalyst is insufficient.

Since the contact of step (B) is allowed to be performed in a relatively wide temperature range, the present invention can be implemented by applying the denitration catalyst to various locations in the space where the exhaust gas flows from a gas turbine to a stack if the locations have a temperature satisfying the above-mentioned wide temperature range. For example, the denitration catalyst may be disposed between a plurality of heat exchange modules, the plurality of heat exchange modules may include a first heat exchange module and a second heat exchange module, the second heat exchange module may be located at the rear end of the first heat exchange module, and the denitration catalyst may be disposed at the rear end of the second heat exchange module. In the zone at the rear end of the second heat exchange module, the exhaust gas may have a temperature range of 450±60° C. under a condition in which the load of the gas turbine is 80% or higher. For example, the load may range from 80% to 100%.

In a conventional selective catalytic reduction (SCR) technology, when the denitration catalyst is located at the rear end of the second heat exchange module, which is a relatively high-temperature heat exchange module, denitration mainly occurs by slow reactions represented by Reaction Formulas (3) and (4). In this case, the amount of the denitration catalyst has to be increased to achieve a desired degree of denitration. Therefore, it has been common to install the denitration catalyst at the rear end of the third heat exchange module, which is a relatively low-temperature heat exchange module. In the zone at the rear end of the third heat exchange module, the exhaust gas may have a temperature range of 350±60° C. under a condition in which the load of the gas turbine is 80% or higher. For example, the load may range from 80% to 100%.

However, when the present invention is used, even in the zone between the second heat exchange module and the third heat exchange module, denitration can be performed by a fast reaction represented by Reaction Formula (2). Therefore, the desired denitration performance can be obtained without increasing the usage of catalyst used. Since the amount of catalyst is not increased, an increase in pressure loss attributable to an increase in the usage of catalyst can be avoided. As described above, the superiority of the present invention can also be confirmed in that the range of selection for the location at which the denitration catalyst can be applied is wider than that in conventional technology. For example, when a relatively long time is required to reach the temperature suitable for selective catalytic reduction (for example, at the time of a cold start), the denitration catalyst may be installed at a position at which the temperature rises faster than a typical denitration catalyst installation position in conventional technology. For example, the denitration catalyst may be installed at a position closer to a gas turbine than the typical denitration catalyst installation position. Therefore, the present invention enables more effective denitration.

In this way, when the denitration catalyst is installed between a plurality of heat exchange modules and is disposed at the rear end of the heat exchange module closest to the gas turbine, the contact between the reducing agent and the NOₓ-containing exhaust gas in step (A) is made in the zone between the gas turbine and the heat exchange module. In this case, the reducing agent and the NOₓ-containing exhaust gas can make a sufficient contact with each other before coming into contact with the denitration catalyst.

As described above, with the use of the present invention, it is possible to effectively treat exhaust gas having a high NO₂ content, which is known to be difficult to be treated in an environment (for example, a low-load operation condition such as a start-up period of a gas turbine) where the temperature of the exhaust gas is low.

Accordingly, for more effective processing of nitrogen oxides, it is preferable that the exhaust gas to be treated contains nitrogen dioxide in a high concentration. For example, the exhaust gas to be treated is preferably a NOₓ-containing exhaust gas generated at the beginning of the start-up operation of a gas turbine (for example, until the load of the gas turbine reaches 400% to 80% of its maximum load). The concentration of nitrogen oxides (NOₓ) in the NOₓ-containing exhaust gas may range from 30 to 100 ppm, and the amount of nitrogen dioxide accounts for 40% to 90% by volume of the total amount of nitrogen oxides in the exhaust gas. The ratio (for example, molar ratio) of nitrogen dioxide to nitrogen monoxide in the NOₓ-containing exhaust gas may exceed 1, may be preferably in a range of 1 to 100, more preferably in a range of 1 to 9, and even more preferably in a range of 2.4 to 9. When the ratio of nitrogen dioxide to nitrogen monoxide in exhaust gas is in any one of the ranges mentioned above, the nitrogen dioxide in the exhaust gas may be easily converted into nitrogen monoxide. That is, the denitration effectively occurs.

In addition, when determining on the basis of the result of reduction of the nitrogen dioxide contained in the NOₓ-containing exhaust gas to nitrogen monoxide by the hydrocarbon-based reducing agent, the molar ratio of nitrogen dioxide to nitrogen monoxide becomes less than 2.49 due to the contact between the reducing agent and the NOₓ-containing exhaust gas in step (A). Preferably, the molar ratio may be 2.33 or less (i.e., in a range of 0 to 2.33). More preferably, the molar ratio may range from 0.43 to 2.33. Even more preferably, the molar ratio may range from 0.67 to 1.5. This is because, as confirmed from the results of experimental examples, denitration occurs relatively easily at such a ratio. This may be because the reaction represented by Reaction Formula (2) and/or Reaction Formula (5) more easily occurs when the ratio is in the range described above. Even the nitrogen monoxide remaining without undergoing a reaction represented by Reaction Formula (2) can be easily reduced to nitrogen molecules by a reaction represented by Reaction Formula (5). Accordingly, the hydrocarbon-based reducing agent is used to maintain the ratio (for example, molar ratio) of nitrogen dioxide to nitrogen monoxide in the contact exhaust gas at less than 2.49, preferably. For example, the ratio is maintained at 2.33 or less (i.e., ranging from 0 to 2.33). More preferably, the ratio is maintained in a range of 0.43 to 2.33. Even more preferably, the ratio is maintained in a range of 0.67 to 1.5.

4NO+4NH₃+O₂→4N₂+6H₂O (5)

When the content of nitrogen oxides in the NOₓ-containing exhaust gas decreases, the content of nitrogen dioxide also decreases, so that the nitrogen oxides can be sufficiently treated with only the ammonia-based reducing agent. In this case, the method of the present invention may further include the step of excluding the hydrocarbon-based reducing agent not to be included in the reducing agent.

For example, the excluding may be carried out when the concentration of nitrogen oxides in the NOₓ-containing exhaust gas is in a range of 5 to 25 ppm. This nitrogen oxide concentration range means a state in which the gas turbine stably operates. During this stable operation of the gas turbine, since the content of nitrogen dioxide in the exhaust gas is not so high, nitrogen oxides can be sufficiently processed by denitration represented by Reaction Formula 5. Therefore, the excluding may be performed according to the operation state of the gas turbine. For example, the excluding may be performed when the load of the gas turbine is 40% or more (i.e., 40% to 100%) of the maximum load, and more preferably when the load is 80% or more (i.e., 80% to 100%). This is because at such a load range of a gas turbine, it is expected that the concentration of nitrogen oxides in exhaust gas is low (for example, 5 to 25 ppm).

In addition, the exhaust gas processing method according to one embodiment of the present invention may further include the step of forming an additional catalyst-contacted exhaust gas. In this step, the catalyst-contacted exhaust gas is brought into contact with an additional denitration catalyst so that the additional catalyst-contacted exhaust gas may be generated. In this step, since nitrogen oxides present in the catalyst-contacted exhaust gas can be reduced by a catalytic reaction on the additional denitration catalyst, the nitrogen oxides can be effectively treated even in a case where the amount of the denitration catalyst used in step (B) is reduced. When the amount of the denitration catalyst is reduced, the exhaust gas can more easily pass through the denitration catalyst, which means that the pressure loss of the exhaust gas can be reduced. That is, that the effect of the present invention is improved. In addition, since the reduction in pressure loss of the exhaust gas means that the power generation efficiency can be increased, the present invention has the effect of improving the power generation efficiency

The contact temperature in the step of forming an additional catalyst-contacted exhaust gas can be reduced compared to the contact temperature in step (B). For example, the contact temperature in the step may be in a range of 200° C. to 400° C. This is because denitration caused by a selective catalytic reduction reaction can easily occur in such as lowered temperature range, and the low contact temperature is favorable in terms of reduction in pressure loss. An additional denitration catalyst may be disposed at a position having a temperature within the temperature range mentioned above. Specifically, the additional denitration catalyst may be disposed at the rear end of the denitration catalyst. For example, the denitration catalyst may be disposed between a plurality of heat exchange modules, in which the plurality of heat exchange modules may include a first heat exchange module, a second heat exchange module, and a third heat exchange module. In this case, the second heat exchange module may be disposed at the rear end of the first heat exchange module, the denitration catalyst may be disposed at the rear end of the second heat exchange module, the third heat exchange module may be disposed at the rear end of the denitration catalyst, and the additional denitration catalyst may be disposed at the rear end of the third heat exchange module.

In addition, the exhaust gas processing method for a thermal power plant, according to one embodiment of the present invention, may further include the step of bringing the catalyst-contacted exhaust gas or the additional catalyst-contacted exhaust gas into contact with an oxidation catalyst. The oxidation catalyst is capable of processing substances that can be processed by an oxidation method or a decomposition method, in which the substances include hydrocarbons such as aldehydes, incomplete combustion products such as carbon monoxide, and unreacted ammonia such as the remaining reducing agent. With the use of the oxidation catalyst, volatile organic compounds, unreacted reducing agents, and the like that may be included in the exhaust gas can also be removed. Such volatile organic compounds may be substances included in NOₓ-containing exhaust gas or may be substances derived from reducing agents. Due to the presence of the step of using the oxidation catalyst, carbon monoxide, volatile organic compounds, etc. contained in NOₓ-containing exhaust gas or derived from reducing agents can also be removed. That is, the exhaust gas generated by a thermal power plant can be more effectively processed. The oxidation catalyst may be disposed at the rear end of the denitration catalyst and may be preferably disposed at the rear end of the additional denitration catalyst. For example, the denitration catalyst may be disposed between a plurality of heat exchange modules, in which the plurality of heat exchange modules may include a first heat exchange module, a second heat exchange module, a third heat exchange module, and a fourth heat exchange module. In this case, the second heat exchange module may be disposed at the rear end of the first heat exchange module, the denitration catalyst may be disposed at the rear end of the second heat exchange module, the third heat exchange module may be disposed at the rear end of the denitration catalyst, the additional denitration catalyst may be disposed at the rear end of the third heat exchange module, the fourth heat exchange module may be disposed at the rear end of the additional denitration catalyst, and the oxidation catalyst may be disposed at the rear end of the fourth heat exchange module.

The denitration catalyst or the additional denitration catalyst applicable to the present invention is not particularly limited. Any substances that can reduce nitrogen oxides to nitrogen molecules through selective catalytic reduction (SCR) can be used as the denitration catalyst or the additional denitration catalyst. For example, the denitration catalyst may be an ammonia-SCR reaction catalyst (for example, a metal oxide catalyst containing vanadium) that is manufactured by a known method such as an ion exchange method or a dry impregnation method or which is commercially available. In addition, the denitration catalyst or the additional denitration catalyst may be a dual functional catalyst to which an oxidation catalytic function is added. In this case, the dual functional catalyst to which an oxidation catalytic function is added refers to a catalyst that can serve as an oxidation catalyst as well as a denitration catalyst. The form and type of the dual functional catalyst are not particularly limited. For example, the dual functional catalyst is structured such that a catalyst component responsible for a denitration function and a catalyst component responsible for an oxidation function are supported together on a single carrier. Preferably, the catalyst component responsible for the denitration function may be disposed in front of the catalyst component responsible for the oxidation function. In this case, the catalyst component responsible for the denitration function may be a vanadium oxide capable of promoting a reduction reaction, and the catalyst component responsible for the oxidation function may be a noble metal-based catalyst. In this case, the noble metal may be platinum, palladium, silver, or the like. As can be seen from the results of experimental examples described below, the dual functional catalyst can inhibit THC generation and ammonia slip and enables more effective processing of exhaust gas in terms of differential pressure.

Preferably, the hydrocarbon-based reducing agent applicable to one embodiment of the present invention is at least one selected from hydrocarbons including at least one hydroxyl group (OH) in the molecule thereof or from saccharides such as sugar. More preferably, the hydrocarbon-based reducing agent is one or more materials selected from ethanol, ethylene glycol, glycerin, sugar, and fructose.

Preferably, the ammonia-based reducing agent applicable to one embodiment of the present invention is at least one selected from among ammonia, urea, and precursors thereof.

In addition, the oxidation catalyst applicable to one embodiment of the present invention is not particularly limited to a specific material. That is, any material that can be applied to a reaction of oxidizing or decomposing a processing target can be used as the oxidation catalyst. For example, the oxidation catalyst may be platinum, palladium, and/or silver. The oxidation catalyst is a substance that can be prepared by a known method or which is commercially available.

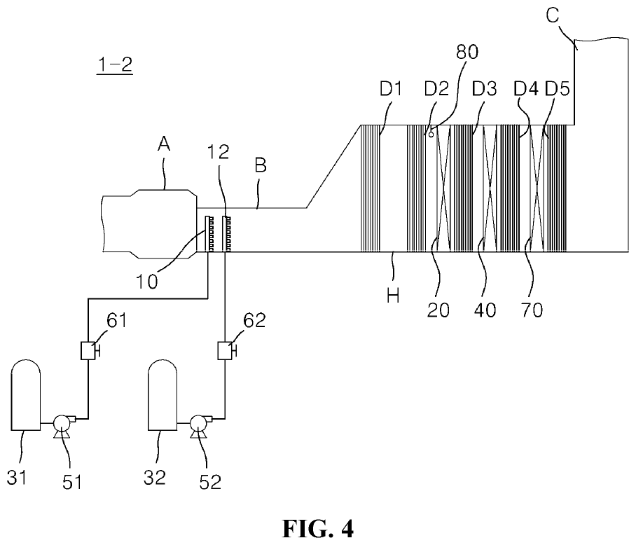

Hereinafter, with reference to FIGS. 2 to 4, a case where an embodiment of the present invention is applied to a thermal power plant will be described in detail. FIG. 2 is a view illustrating an exhaust gas processing apparatus with which an exhaust gas processing method for a thermal power plant, according to one embodiment of the present invention, can be implemented. FIG. 3 is a view illustrating an arrangement structure according to a first modification to the exhaust gas processing apparatus of FIG. 2. FIG. 4 is a view illustrating an arrangement structure according to a second modification to the exhaust gas processing apparatus of FIG. 2.

An exhaust gas processing apparatus 1 illustrated in FIG. 2 includes: a reducing agent injection unit 10 disposed in an exhaust gas passage B between a gas turbine A and a chimney C and at the rear end of the gas turbine A; reducing agent tanks 31 and 32 containing reducing agents for reducing nitrogen oxides contained in exhaust gas flowing through the exhaust gas passage B; and a denitration catalyst module 20 disposed at the rear end of the reducing agent injection unit 10. The multiple reducing agent tanks 31 and 32 may store different reducing agents, respectively. For example, a hydrocarbon-based reducing agent may be stored in a first reducing agent tank 31, and an ammonia-based reducing agent may be stored in a second reducing agent tank 32. The reducing agent tanks 31 and 32 and the reducing agent injection unit 10 may be connected by a pipeline structure. In this case, a pump for moving a fluid by inducing a pressure difference and valves capable of controlling the flow rate of the fluid may be installed on each pipeline structure. For example, first and second control valves 61 and 62 for controlling the flow rates of the respective reducing agents flowing through the pipelines, and first and second supply pumps 51 and 52 for pumping the reducing agents may be installed as illustrated. The valves and pumps are controlled to adjust the flow rate of a hydrocarbon-based reducing agent for reducing nitrogen dioxide to nitrogen monoxide, thereby adjusting the ratio of nitrogen dioxide to nitrogen monoxide in a contact exhaust gas to be maintained in a preferable range.

The form or installation position of the reducing agent injection unit 10 are not limited to the illustrated form and position. The form and position do not matter as long as the reducing agent can be injected into the exhaust gas passage. The reducing agent injection unit 10 may have an arbitrary form such as a nozzle structure or a grid structure and may be arbitrarily positioned, for example, across the passage or on the wall surface of the passage.

In addition, the denitration catalyst module 20 may include a denitration catalyst in a state supported on a support, and the denitration catalyst module 20 may be disposed between a plurality of heat exchange modules. That is, the denitration catalyst module 20 may be installed in the space among a first heat exchange module D1, a second heat exchange module D2, a third heat exchange module D3, a fourth heat exchange module D4, and a fifth heat exchange module D5 of a waste heat recovery boiler H of a combined-cycle power plant. As illustrated in the drawings, the denitration catalyst module 20 may be positioned between the second heat exchange module D2 and the third heat exchange module D3. Although not illustrated in the drawings, the upper and lower ends of the respective heat exchange modules D1 to D5 may be connected to each other, and tanks for storing and circulating high-pressure steam or heat recovery fluid is installed at the joint portions of the heat exchange modules. The heat exchange modules D1 to D5 are configured such that the fluid can sequentially circulate from the last-stage module D5 to the first-stage module D1, and may generate high-pressure steam. The temperatures of the respective heat exchange modules D1 to D5 may be in descending order from the temperature of the first-stage module D1 to the temperature of the last-stage module D5.

After the start-up of the gas turbine A, when the temperature of the exhaust gas in the passage rises and the area where the denitration catalyst module is disposed has a temperature in a range of 200° C. to 500° C., a hydrocarbon-based reducing agent and an ammonia-based reducing agent are injected into a zone of the passage through the reducing agent injection unit 10. Specifically, the reducing agents are injected into the zone where the exhaust gas exhibits a temperature in a range of 300° C. to 500° C. so that a contact exhaust gas is formed in the front end of a denitration catalyst. Since the contact exhaust gas is contacted with the denitration catalyst in a temperature range of 200° C. to 500° C., effective denitration can be performed.

This process may be carried out until the load of the gas turbine reaches preferably 40%, more preferably 80% of the maximum load in terms of the gas turbine operating conditions. When, the load of the gas turbine preferably reaches 40% of the maximum load and more preferably reaches 80% of the maximum load, the first control valve 61 is closed, and the operation of the first supply pump 51 is stopped so that the hydrocarbon-based reducing agent cannot be included in the reducing agent. This process may be performed not only according to the gas turbine operating conditions but also according to the nitrogen oxide concentration in nitrogen oxide (NOₓ)-containing exhaust gas. For example, when the nitrogen oxide concentration in the NOₓ-containing exhaust gas is in a range of 30 to 100 ppm, the hydrocarbon-based reducing agent and the ammonia-based reducing agent are introduced into the passage. However, when the nitrogen oxide concentration in the NOₓ-containing exhaust gas is in a range of 5 to 25 ppm, the first control valve 61 is closed and the operation of the first supply pump 51 is stopped so that the hydrocarbon-based reducing agent cannot be introduced into the passage. In this case, the reducing agent does not include the hydrocarbon-based reducing agent.

In addition, with the use of an exhaust gas processing apparatus 1-1 shown in FIG. 3, the step of forming an additional catalyst-contacted exhaust gas may be performed. The exhaust gas processing apparatus 1-1 illustrated in FIG. 3 is the same as the exhaust gas processing apparatus 1 shown in FIG. 1 except that an additional denitration catalyst module 40 including an additional denitration catalyst and an oxidation catalyst module 70 including an oxidation catalyst are added. Accordingly, in order to avoid redundancy, hereinafter, a description will be made focusing on the added parts of the apparatus 1-1 illustrated in FIG. 3, excluding a description about the same parts as in the exhaust gas processing apparatus 1 illustrated in FIG. 2. The additional denitration catalyst module 40 is disposed between the third heat exchange module D3 and the fourth heat exchange module D4. The catalyst-contacted exhaust gas comes into contact with the additional denitration catalyst under a temperature condition of 200° C. to 400° C. so that nitrogen oxides present in the catalyst-contacted exhaust gas can be reduced to produce an additional catalyst-contacted exhaust gas. The additional catalyst-contacted exhaust gas thus formed comes into contact with the oxidation catalyst disposed between the fourth heat exchange module D4 and the fifth heat exchange module D5 so that carbon monoxide and volatile organic compounds present in the additional catalyst-contacted exhaust gas can be removed by an oxidation reaction on the catalyst.

In addition, like an exhaust gas processing apparatus 1-2 shown in FIG. 4, an additional reducing agent injection unit 12 may be added in addition to the reducing agent injection unit 10. In addition, a measurement sensor such as a nitrogen oxide measurement sensor for measuring nitrogen oxides (NO, NO₂ and/or NOₓ) may be added. In this case, one embodiment may be implemented in a state in which the reducing agents are separately injected and/or the concentration of nitrogen oxides is measured with the sensor.

As illustrated in FIG. 4, the first reducing agent tank 31 is connected to the reducing agent injection unit and the second reducing agent tank 32 is connected to the additional reducing agent injection unit. The reducing agent tanks contain a hydrocarbon-based reducing agent and an ammonia-based reducing agent, respectively, and the reducing agents are separately injected into the exhaust gas through the respective injection units. In this way, the content of the reducing agent to come into contact with the exhaust gas can be adjusted. The adjustment of the content of each of the reducing agents may be performed according to the measurement value of the concentration of nitrogen oxides (NO, NO₂, and/or NOₓ), which is measured with the measurement sensor. By controlling the reducing agent content according to the measurement value, only the optimal amount of the reducing agent required for denitrification is consumed. Thus, concerns about problems caused by the remaining reducing agent can also be avoided.

Hereinafter, the effects of the present invention will be described in more detail with reference to experimental examples. Hereinafter, in the description of the experimental examples, the constituent parts described above will not be denoted by reference symbols.

### <Experimental Example 1> Experiment for Confirmation of Denitration Effect

Pseudo exhaust gas in which O₂ accounts for 15%, nitrogen monoxide (NO) is contained in a concentration of 20 ppm, nitrogen dioxide (NO₂) is contained in a concentration of 80 ppm, and N₂ is contained as the balance was prepared. A catalyst test device was configured such that the prepared pseudo exhaust gas was supplied by a mass flow controller (MFC) to pass through a catalyst test device. In the experiment, a mixed gas containing NO and NO₂ in a concentration of 1% (balance gas N₂) was used to prepare the pseudo exhaust gas. An SCR catalyst (obtained from IB Materials Co., Ltd.) was installed in the catalyst test device, and an electric heater and a cooler were installed to control a reaction temperature. The space velocity of the SCR catalyst was 23,000±3,000 hr⁻¹. A mixer was used such that ammonia and ethylene glycol were mixed with the pseudo exhaust gas and the resulting mixture was passed through the catalyst test device. An electric heater and a cooler were also installed in the mixer so that the reducing agents and the pseudo exhaust gas were brought into contact with each other at 400±4° C. Ammonia was injected into the mixer after the molar ratio of NH₃ to NOₓ was adjusted to 1.26 in front of the mixer. In this case, as the ammonia, 1% ammonia gas (balance gas N₂) was used, and the injection flow rate of the ammonia gas was adjusted with the MFC. In addition, the injection amount of ethylene glycol was adjusted with a metering pump. When the ethylene glycol was injected, the injection molar ratio of ethylene glycol to NO₂ was adjusted and the denitration rate was measured at various temperatures. The reaction temperature of the SCR catalyst was changed in a range of from 175° C. to 550° C., and the effect on denitration was checked at each temperature interval in that range. At this time, the reaction temperature range of 500° C. or less is selected in consideration of the reaction temperature range that can be reached when the reducing agent and the exhaust gas come into contact with each other at 300° C. to 500° C. In order to identify such an effect, the experiment was conducted by raising the temperature of the catalyst test device up to 550° C. which exceeds the temperature of 500° C. The denitration rate was calculated for each condition, and the results are shown in a table shown below.

TABLE 1
Denitration rate(%)

| | Ethylene glycol injection ratio | | | | | |
|---|---|---|---|---|---|---|
| | (ratio of ethylene glycol to NO₂) | | | | | |
| Reaction temperature (° C.) | 0 | 0.1 | 0.2 | 0.3 | 0.4 | 0.5 |
| 175 | 18 | 30 | 44 | 58 | 60 | 62 |
| 200 | 22 | 37 | 50 | 70 | 73 | 75 |
| 225 | 29 | 45 | 58 | 77 | 80 | 83 |
| 250 | 40 | 54 | 68 | 83 | 86 | 89 |
| 300 | 67 | 75 | 83 | 92 | 95 | 96 |
| 350 | 88 | 91 | 93 | 96 | 98 | 99 |
| 400 | 90 | 92 | 92 | 93 | 93 | 95 |
| 450 | 83 | 83 | 83 | 84 | 86 | 88 |
| 475 | 72 | 72 | 73 | 77 | 80 | 82 |
| 500 | 56 | 58 | 60 | 65 | 71 | 73 |
| 525 | 42 | 43 | 43 | 44 | 44 | 45 |
| 550 | 23 | 23 | 23 | 24 | 24 | 25 |

As shown in Table 1, when the concentration of NO₂ in the exhaust gas was about 80 ppm (NO₂/NOₓ=0.8), when only ammonia was used as the reducing agent (i.e., when the ethylene glycol injection content was 0), a denitration rate of 70% or more was obtained in a temperature range that is 350° C. or higher. However, when ethylene glycol was included in the reducing agent, even when the reaction temperature was 300° C. or lower, a denitration rate of 70% or more was achieved, and the denitration rate increased with an increase in the ethylene glycol content. For example, when the ratio of ethylene glycol/NO₂ was 0.3 or more, a denitration rate of 70% or more was achieved even when the reaction temperature was 200° C. However, when the reaction temperature was lower than 200° C. or the reaction temperature was higher than 500° C., the denitration rate did not reach 70% even though the ethylene glycol content was increased. Accordingly, with the use of the present invention, it seems that the exhaust gas having a high nitrogen dioxide content can be easily appropriately processed in a reaction temperature range of 200° C. to 500° C. From these results, it is concluded that when exhaust gas is treated according to the present invention, the exhaust gas containing a high concentration of nitrogen dioxide can be easily processed through catalytic reactions in a wider reaction temperature range than conventional technology.

### <Experimental Example 2> Experiment for Confirmation of Influence of Contact Temperature on Denitration

Hereinafter, by using the result of Experimental Example 1, how a contact temperature at which exhaust gas and a reducing agent come into contact with each other influences denitrification of exhaust gas was investigated. Changes in denitration rate were observed in a condition in which the reaction temperature was fixed to 300° C. and the temperature for contact between the reducing agent and the exhaust gas was varied. The fixed catalytic reaction temperature of 300° C. was determined by selecting a relatively low temperature among the reaction temperatures at which a denitration rate of 90% or more could be obtained, on the basis of the results of Experimental Example 1. Specifically, a first chamber and a second chamber were arranged such that the contact of the exhaust gas was performed in the first chamber and the contact of the catalyst was performed in the second chamber disposed in the rear end of the first chamber. A SCR catalyst (obtained from IB Materials Co., Ltd.) was installed in the second chamber. Electric heaters were installed in front of the first chamber and the second chamber, respectively, and an air-cooling cooler was installed in front of the second chamber to control the reaction temperature. Pseudo exhaust gas {O₂ 15%, NO 14 ppm, NO₂ 60 ppm} was injected into the first chamber, the temperature was raised to the exhaust gas contact temperature shown in Table 2, then ethylene glycol (in an ethylene glycol/NO₂ molar ratio of 0.4) and ammonia (in an NH₃/NOₓ molar ratio of 1.27) were injected to be mixed with the pseudo exhaust gas, and the resulting mixture was retained for a sufficient retention time (for example, 0.8 second) in the first chamber. Next, the degree of conversion from nitrogen dioxide to nitrogen monoxide was measured, the conversion rate was calculated. The calculated conversion rates are summarized in Table 2. The temperature of the contact exhaust gas discharged from the first chamber was adjusted with the electric heater and the air-cooling cooler such that the reaction temperature in the second chamber becomes 300° C. In this way, a catalytic denitration reaction was performed. In the experiment, the space velocity of the SCR catalyst was 45000 hr⁻¹. The denitration rates through the catalytic reaction were calculated. The results are summarized in Table 2. In order to observe whether nitrogen monoxide converted from nitrogen dioxide is maintained at the catalytic reaction temperature when the exhaust gas contact temperature and the catalytic reaction temperature are different, the ratio of NO₂/NOₓ was measured in front of the second chamber. There was no significant difference between the NO₂/NOₓ ratio which was measured in the first chamber and the NO₂/NOₓ ratio which was measured in front of the second chamber. This means that the NO₂ conversion rate at the reducing agent contact temperature shown in Table 2 was maintained even at the catalytic reaction temperature.

In addition, Table 2 shows the ratio of nitrogen dioxide to nitrogen monoxide (NO₂/NO) in the contact exhaust gas. The NO₂/NO ratio in the contact exhaust gas was calculated by dividing the concentration of NO₂ remaining in the exhaust gas after the conversion by the concentration of NO (i.e., NO concentration before conversion plus NO concentration newly generated through the conversion) existing in the exhaust gas after the conversion.

TABLE 2

| Reducing | NO₂ | NO₂/NO | Catalytic reaction |
|---|---|---|---|
| agent contact | conversion | ratio in contact | denitration |
| temperature (° C.) | ratio (%) | exhaust gas | rate (%) |
| 260 | 8 | 2.94 | 34 |
| 280 | 12 | 2.49 | 48 |
| 300 | 25 | 1.55 | 71 |
| 320 | 36 | 1.08 | 85 |
| 340 | 47 | 0.75 | 90 |
| 360 | 49 | 0.71 | 99 |
| 380 | 50 | 0.68 | 99 |
| 400 | 53 | 0.62 | 94 |
| 420 | 50 | 0.68 | 96 |
| 440 | 48 | 0.73 | 95 |
| 460 | 48 | 0.73 | 91 |
| 480 | 41 | 0.92 | 87 |
| 500 | 19 | 1.91 | 64 |
| 520 | 4 | 3.51 | 44 |
| 540 | −9 | 7.60 | 25 |

From the results of Table 2, it can be seen that nitrogen dioxide is very effectively converted to nitrogen monoxide when the reducing agent comes into contact with the exhaust gas at a temperature in a range of 300° C. to 500° C., and more preferably at a temperature in a range of 320° C. to 480° C., denitration occurs effectively by such a conversion. In this case, the ratio of NO₂ to NO in the contact exhaust gas was found to be preferably less than 2.49.

### <Experimental Example 3> Effect of NO₂/NO Ratio in the Contact Exhaust Gas on Denitration

Hereinafter, by using the results of Experimental Example 2, the effect of the change in the NO₂/NO ratio in the contact exhaust gas on the denitration rate was investigated.

The reaction temperature was fixed at 300° C. in the same manner as in Experimental Example 2, but the present experiment was conducted while changing the NO₂/NO ratio in the contact exhaust gas. In the present experiment, the space velocity of the SCR catalyst was different from that used in Experimental Example 2. This was to observe changes in denitration effect according to changes in the NO₂/NO ratio in the contact exhaust gas. In order to produce pseudo contact exhaust gas in which the ratio of NO₂ to NO is adjusted, nitrogen gas was used as a balance gas, the concentration of oxygen (O₂) was adjusted to 15%, and the concentrations of NO and NO₂ were adjusted to the values shown in the following table. An SCR catalyst (obtained from IB Materials Co., Ltd.) was installed in the catalyst test device, and an electric heater and a cooler were installed to control a reaction temperature. The space velocity of the SCR catalyst was 30,000±2,000 hr⁻¹. A mixer was used such that ammonia was mixed with the pseudo exhaust gas and the resulting mixture was passed through the catalyst test device. The mixer was equipped with an electric heater and a cooler to adjust the mixing temperature. Ammonia was injected into the mixer after the molar ratio of NH₃NOₓ was adjusted to 1.2 in front of the mixer. In this case, as the ammonia, 1% ammonia gas (balance gas N₂) was used, and the injection flow rate of the ammonia gas was adjusted with the MFC. The denitration rate was calculated for each condition, and the results are shown in the following table.

TABLE 3

| NO₂/NO ratio in | Catalytic reaction |
|---|---|
| contact exhaust gas | denitration rate (%) |
| 2.49 | 77 |
| 2.33 | 81 |
| 1.50 | 90 |
| 0.67 | 94 |
| 0.43 | 86 |
| 0.40 | 78 |

As shown in Table 3, when the NO₂/NO ratio in the contact exhaust gas was 2.33 or less, preferably in a range of 0.43 to 2.33, effective denitration was achieved. When the NO₂/NO ratio was in a range of 0.67 to 1.5, denitration was most effectively performed.

From these results, it is concluded that the NO₂/NO ratio in the contact exhaust gas is preferably 2.33 or less, more preferably 0.43 to 2.33, and most preferably 0.67 to 1.5.

Therefore, the hydrocarbon-based reducing agent is used to maintain such a NO₂/NO ratio range. That is, the hydrocarbon-based reducing agent is used to maintain the ratio (for example, molar ratio) of NO₂ to NO in the contact exhaust gas at 2.33 or less. More preferably, the ratio is maintained in a range of 0.43 to 2.33. Even more preferably, the ratio is maintained in a range of 0.67 to 1.5.

### <Experimental Example 4> Experiment to Confirm Denitration Effect and Oxidation Effect

An oxidation catalyst was added to the denitration catalyst used in Experimental Example 1, an experiment was conducted to confirm the denitration and oxidation effects on pseudo exhaust gas (O₂ 15%, NO 20 ppm, NO₂ 80 ppm, propane (C₃H₈) 15 ppm, and balance gas N₂). The propane was a component added to objectively determine the THC removal effect. For the control of the concentration of propane, a mass flow controller (MFC) was used to supply propane gas (1% propane, balance gas N₂). When the oxidation catalyst is added to the denitration catalyst, the oxidation catalyst and the denitration catalyst were supported on respectively separate carriers or were supported on the same carrier. In the case in which the oxidation catalyst and the denitration catalyst are supported on respective carriers, a platinum-based oxidation catalyst (manufactured by IB Materials Co., Ltd.) was additionally purchased and added to the SCR catalyst used in Test Example 1. The space velocity of the platinum-based oxidation catalyst was 60,000 hr⁻¹. In order to use the oxidation catalyst and the denitration catalyst supported on the same carrier, platinum nitrate was diluted with DI water, and then about 40% of the area of the SCR catalyst used in Experimental Example 1 was coated with the diluted solution such that the content of platinum (Pt) with respect to the total weight of the catalyst became 0.05 wt %. Then, it was dried at 120° C. for 4 hours and fired at 500° C. for 5 hours to prepare a dual functional catalyst.

A catalyst test device and a mixer used in this experiment were the same as used in Experimental Example 1. Reducing agents were brought into contact with exhaust gas at 400° C. The experiment was performed in the presence and absence of ethylene glycol, and the type of the oxidation catalyst used was changed in the experiment. In the experiment, ammonia was supplied in an amount corresponding to an NH₃/NOₓ ratio=1.2, and ethylene glycol was supplied in an amount corresponding to an ethylene glycol/NO₂ molar ratio=0.4. As the experiment results, a denitration rate, a total hydrocarbon (THC) removal rate, an ammonia slip concentration, and a differential pressure change for each condition were obtained. The experiment results are summarized in Tables 4 to 7. Table 4 shows the experiment results for a case where only ammonia was used as a reducing agent and only an SCR catalyst was used as a catalyst, and Tables 5 and 6 show the experiment results for a case where ammonia and ethylene glycol were used together as a reducing agent and an oxidation catalyst and a denitration catalyst were used. Table 5 shows the experiment results for a case where the oxidation catalyst and the denitration catalyst supported on respective carriers were used, and Table 6 shows the experiment results for a case where a dual functional catalyst was used. Table 7 shows the experiment results of the differential pressure change for each of the cases at a reaction temperature of 380° C. In Table 7, ND refers to “not detected”.

TABLE 4

| Reaction temperature | Denitration | THC removal | Ammonia slip |
|---|---|---|---|
| (° C.) | rate (%) | rate (%) | (ppm) |
| 175 | 16 | 10 or less | 50 or more |
| 200 | 21 | 10 or less | 50 or more |
| 225 | 30 | 10 or less | 50 or more |
| 250 | 38 | 10 or less | 50 or more |
| 300 | 65 | 10 or less | 38 |
| 350 | 86 | 10 or less | 15 |
| 400 | 90 | 10 or less | 8 |
| 450 | 83 | 10 or less | 5 |
| 475 | 70 | 10 or less | 4 |
| 500 | 56 | 10 or less | 4 |
| 525 | 40 | 10 or less | 3 |

TABLE 5

| Reaction temperature | Denitration | THC removal | Ammonia slip |
|---|---|---|---|
| (° C.) | rate (%) | rate (%) | (ppm) |
| 175 | 39 | 77 | 5 |
| 200 | 73 | 82 | 3 |
| 225 | 81 | 89 | 1 |
| 250 | 86 | 97 | ND |
| 300 | 94 | 99 or more | ND |
| 350 | 97 | 99 or more | ND |
| 400 | 93 | 99 or more | ND |
| 450 | 84 | 99 or more | ND |
| 475 | 78 | 99 or more | ND |
| 500 | 70 | 99 or more | ND |
| 525 | 42 | 99 or more | ND |

TABLE 6

| Reaction temperature | Denitration | THC removal | Ammonia slip |
|---|---|---|---|
| (° C.) | rate (%) | rate (%) | (ppm) |
| 175 | 38 | 78 | 2 |
| 200 | 72 | 86 | 1 |
| 225 | 82 | 93 | ND |
| 250 | 87 | 96 | ND |
| 300 | 95 | 99 or more | ND |
| 350 | 96 | 99 or more | ND |
| 400 | 95 | 99 or more | ND |
| 450 | 83 | 99 or more | ND |
| 475 | 75 | 99 or more | ND |
| 500 | 68 | 99 or more | ND |
| 525 | 41 | 99 or more | ND |

TABLE 7

| | Only SCR | Ethylene glycol | Ethylene glycol and |
|---|---|---|---|
| | catalyst and | and oxidation | dual functional |
| Classification | ammonia | catalyst | catalyst |
| Differential | 24 | 50 | 28 |
| Pressure(mmH₂O) | | | |

From the experiment results in Tables 4 to 7, it is concluded that when a hydrocarbon-based reducing agent and an ammonia-based reducing agent are used together, denitration is effectively performed in a relatively wide temperature range. In addition, it is seen that THC generation and ammonia slip can be effectively inhibited in the case where the oxidation catalyst and the denitration catalyst are used together. Moreover, it is seen that when the oxidation catalyst and the denitration catalyst are used in the form of a dual functional catalyst, exhaust gas treatment is more effective in terms of pressure difference.

From the experiment results, it is concluded that according to the present invention, even exhaust gas having a high content of nitrogen dioxide (for example, exhaust gas generated at the time of start-up of a combined cycle power plant) can be effectively treated.

While exemplary embodiments of the present invention have been described with reference to the accompanying drawings and experimental examples, those skilled in the art will appreciate that the present invention can be implemented in other different forms without departing from the technical spirit or essential characteristics of the exemplary embodiments. Therefore, it can be understood that the exemplary embodiments described above are only for illustrative purposes and are not restrictive in all aspects.

### EXPLANATION OF REFERENCE NUMERALS IN THE DRAWINGS

1, 1-1, 1-2: Exhaust gas processing apparatus 10: Reducing agent injection unit
12: Additional reducing agent injection unit 20: Denitration catalyst module
31: First reducing agent tank 32: Second reducing agent tank
40: Additional denitration catalyst module 51: First supply pump
52: Second supply pump 61: First control valve
62: Second control valve 70: Oxidation catalyst module
80: Measurement sensor A: Gas turbine
B: Exhaust gas passage C: Chimney
D1: First heat exchange module D2: Second heat exchange module
D3: Third heat exchange module D4: Fourth heat exchange module
D5: Fifth heat exchange module H: Waste heat recovery boiler

### INDUSTRIAL APPLICABILITY

With an exhaust gas processing method for a thermal power plant, according to the present invention, it is possible to very effectively and efficiently process exhaust gas of a thermal power plant. Accordingly, the present invention is useful in industry.

1. A method of processing exhaust gas of a thermal power plant, the method comprising the steps of:
(A) forming a contact exhaust gas by bringing a reducing agent including a carbon-based reducing agent and an ammonia-based reducing agent into contact with a nitrogen oxide (NOₓ)-containing exhaust gas at a temperature in a range of 300° C. to 500° C. at a front end of a denitration catalyst; and
(B) bringing the contact exhaust gas into contact with the denitration catalyst to form a catalyst-contacted exhaust gas,
wherein in step (A), the contact is made at a position between a gas turbine and a heat exchange module, and the contact exhaust gas is formed by injecting the hydrocarbon-based reducing agent and the ammonia-based reducing agent into a gas passage through which the NOₓ-containing exhaust gas flows.

2. The method of claim 1, wherein the contact in step (A) is made to allow the hydrocarbon-based reducing agent to reduce nitrogen dioxide (NO₂) contained in the NOₓ-containing exhaust gas to nitrogen monoxide (NO).

3. The method of claim 2, wherein the hydrocarbon-based reducing agent is included in the reducing agent in an amount of 0.5 equivalents of the nitrogen dioxide at maximum.

4. The method of claim 1, wherein the contact in step (B) is made at a temperature in a range of 200° C. to 500° C.

5. The method of claim 1, wherein the NOₓ-containing exhaust gas contains nitrogen oxides in a concentration of 30 to 100 ppm.

6. The method of claim 1, wherein the amount of nitrogen dioxide accounts for 40% to 90% by volume of the amount of nitrogen oxides contained in the NOₓ-containing exhaust gas.

7. The method of claim 1, wherein a ratio of nitrogen dioxide to nitrogen monoxide in the NOₓ-containing exhaust gas exceeds 1.

8. The method of claim 1, wherein the hydrocarbon-based reducing agent is used to maintain a ratio of nitrogen dioxide to nitrogen monoxide in the contact exhaust gas at 2.33 or less.

9. The method of claim 1, wherein a ratio of nitrogen dioxide to nitrogen monoxide in the contact exhaust gas is maintained at 2.33 or less by the contact made in step (A).

10. The method of claim 1, wherein the contact in step (A) is performed according to the amount of the hydrocarbon-based reducing agent, which is adjusted depending on the measured value of a nitrogen dioxide concentration in the NOₓ-containing exhaust gas, the concentration being measured at the front end of the denitration catalyst.

11. The method of claim 1, wherein the denitration catalyst is disposed between a plurality of heat exchange modules, the plurality of heat exchange modules comprises a first heat exchange module and a second heat exchange module, the second heat exchange module is disposed at the rear end of the first heat exchange module, and the denitration catalyst is disposed at the rear end of the second heat exchange module.

12. The method of claim 1, further comprising the step of excluding the hydrocarbon-based reducing agent so that the reducing agent does not contain the hydrocarbon-based reducing agent.

13. The method of claim 12, wherein the excluding is carried out when the concentration of nitrogen oxides in the NOₓ-containing exhaust gas is in a range of 5 to 25 ppm.

14. The method of claim 12, wherein the excluding is carried when the gas turbine of the thermal power plant exhibits 40% or more of the maximum output thereof.

15. The method of claim 1, further comprising the step of forming an additional catalyst-contacted exhaust gas by bringing the catalyst-contacted exhaust gas into contact with an additional denitration catalyst.

16. The method of claim 15, wherein the contact in the step of forming the additional catalyst-contacted exhaust gas is made at a temperature in a range of 200° C. to 400° C.

17. The method of claim 15, wherein the denitration catalyst is disposed between a plurality of heat exchange modules, the plurality of heat exchange modules comprises a first heat exchange module, a second heat exchange module, and a third heat exchange module, the second heat exchange module is disposed at the rear end of the first heat exchange module, the denitration catalyst is disposed at the rear end of the second heat exchange module, the third heat exchange module is disposed at the rear end of the denitration catalyst, and the additional denitration catalyst is disposed at the rear end of the third heat exchange module.

18. The method of claim 15, further comprising the step of brining the additional catalyst-contacted exhaust gas into contact with an oxidation catalyst.

19. The method of claim 18, wherein the denitration catalyst is disposed between a plurality of heat exchange modules, the plurality of heat exchange modules comprises a first heat exchange module, a second heat exchange module, a third heat exchange module, and a fourth heat exchange module, the second heat exchange module is disposed at the rear end of the first heat exchange module, the denitration catalyst is disposed at the rear end of the second heat exchange module, the third heat exchange module is disposed at the rear end of the denitration catalyst, the additional denitration catalyst is disposed at the rear end of the third heat exchange module, the fourth heat exchange module is disposed at the rear end of the additional denitration catalyst, and the oxidation catalyst is disposed at the rear end of the fourth heat exchange module.

20. The method of claim 1, wherein the denitration catalyst is a double-functional catalyst having an oxidation catalytic function as well as a denitration catalytic function.
